(19) United States
(12) Patent Application Publication
(10) Pub. No.: US 2018/0356075 A1
(43) Pub. Date: Dec. 13, 2018

(54) Zoned Optical Cup

(71) Applicant: EcoSense Lighting, Inc., Los Angeles, CA (US)

(72) Inventors: Raghuram L.V Petluri, Los Angeles, CA (US); Paul Kenneth Pickard, Los Angeles, CA (US)

(73) Assignee: EcoSense Lighting, Inc., Los Angeles, CA (US)

(21) Appl. No.: 16/048,170

(22) Filed: Jul. 27, 2018

Related U.S. Application Data
(63) Continuation of application No. PCT/US16/15470, filed on Jan. 28, 2016.

(51) Int. Cl. F21V 13/08; F21V 9/30; F21V 7/00; F21K 9/62

(52) U.S. Cl. CPC F21V 13/08; F21V 9/30; F21Y 2115/10; F21K 9/62; F21V 7/0083

(57) ABSTRACT

An optical plate having discreet zones including a molded substantially planar plate with an annular edge; a top surface and a bottom surface; a plurality of separate transmissive regions or zones on the top surface of the plate; an attachment located on along the circumference of the plate; and, a phosphor mix in each region.

### FIELD

A reflecting system and apparatus to direct light emitting diode illumination to a multi phosphor zone disk.

### BACKGROUND

A wide variety of light emitting devices are known in the art including, for example, incandescent light bulbs, fluorescent lights, and semiconductor light emitting devices such as light emitting diodes (“LEDs”).

White light may be produced by utilizing one or more luminescent materials such as phosphors to convert some of the light emitted by one or more LEDs to light of one or more other colors. The combination of the light emitted by the LEDs that is not converted by the luminescent material(s) and the light of other colors that are emitted by the luminescent material(s) may produce a white or near-white light.

The luminescent materials such as phosphors, to be effective at absorbing light, must be in the path of the emitted light. Phosphors placed at the chip level will be in the path of substantially all of the emitted light, however they also are exposed to more heat than a remotely placed phosphor. Because phosphors are subject to thermal degradation by separating the phosphor and the chip thermal degradation can be reduced. Separating the phosphor from the LED has been accomplished via the placement of the LED at one end of a reflective chamber and the placement of the phosphor at the other end. Traditional LED reflector combinations are very specific on distances and ratio of angle to LED and distance to remote phosphor or they will suffer from hot spots, thermal degradation, and uneven illumination. It is therefore a desideratum to provide an LED and reflector with remote photoluminescence materials that does not suffer from these drawbacks.

### DISCLOSURE

Devices, systems and methods are disclosed herein directed to aspects of illumination. More specifically, related to aspects of modifying the illumination from multiple light emitting diodes (LEDs) via directing illumination through separate cavities to selected phosphors which converts the wavelength of each illumination input into a different wavelength output.

The disclosure teaches aspects of systems of modular sub components to allow standardized sizing for reflector bodies and cavities and/or board (surface) mounting features and cooperating selectable lumo converting appliances (LCA) in the form of optical plates, chips, or overlays, having one or more of surface coating and suspended particles to select each output from each cavity. In some instances at least one cavity may have phosphor coatings therein to cooperate with the LCA in producing a selected output; in some instances to allow for fine tuning and adjustment for a blended output.

Disclosed herein are aspects of exemplary implementations of devices and systems of transmissive optical plates having discreet zones including at least a molded generally planar plate with an annular edge; a top surface and a bottom surface; a plurality of separate transmissive regions or zones on the top surface of the plate; an attachment located on along the circumference of the plate; and, a photoluminescence material such as a phosphor mix or quantum dots in each region. In some instances the plate is generally one of circular, ovoid, or polygonal. The plate may have the attachment along its periphery or the attachment may be on the bottom surface of the plate or the bottom surface of the plate near the periphery. In some instances there is a positioning cue to align the transmissive regions of the plate in a predetermined orientation over a plurality of illumination sources.

Disclosed herein are aspects of exemplary implementations of devices and systems of transmissive optical plates having discreet zones including at least a molded generally planar plate with an annular edge; a top surface and a bottom surface; a plurality of separate transmissive regions or zones on the top surface of the plate; the top is formed of one or more of polymers, plastics, glass sapphire and has an attachment; and, a photoluminescence material such as a phosphor mix or quantum dots associated with each region.

Disclosed herein are aspects of exemplary implementations of devices and systems of transmissive optical plates having discreet zones including at least a molded generally planar plate with an annular edge; a top surface and a bottom surface; a plurality of separate transmissive regions or zones on the top surface of the plate; each transmissive region is formed of at least one of phosphor doped epoxy, phosphor doped silicone rubber, phosphor doped PET, and phosphor doped polymer; and, a photoluminescence material such as a phosphor mix or quantum dots in each region. In some instances the phosphor doping is substantially uniform in the region. In some instances the phosphor doping is non-uniform in the region.

Disclosed herein are aspects of exemplary implementations of devices and systems of transmissive optical plates having discreet zones including a generally planar plate with an annular edge, top and bottom surfaces and having a plurality of open lumo guides forming zones there through; an attachment located on along the circumference of the plate; and, a lumo converting appliance (LCA) containing at least a photoluminescence material such as a phosphor mix or quantum dots associated with each LCA affixed in each guide.

Disclosed herein are aspects of exemplary implementations of devices and systems of transmissive optical plates having discreet zones including a generally planar plate with an annular edge, top and bottom surfaces and having a plurality of open lumo guides forming zones there through; an attachment located on along the circumference of the plate; and, a lumo converting appliance (LCA) containing at least a photoluminescence material such as phosphor doped epoxy, phosphor doped silicone rubber, phosphor doped PET, and phosphor doped polymer affixed in each guide.

Disclosed herein are aspects of exemplary implementations of devices and systems of transmissive optical plates having discreet zones including a generally planar plate with an annular edge, top and bottom surfaces and having a plurality of open lumo guides forming zones there through; an attachment located on along the circumference of the plate; and, a lumo converting appliance (LCA) having a transmissive base formed of at least one of glass, sapphire, and polymer coated with a binder containing one or more phosphors or quantum dots affixed in each guide.

Disclosed herein are aspects of exemplary implementations of a molded reflector body having a common body with a shared top and a plurality of reflective cavities each having an open input end and open output end; the output end aligned with the shared top; and, a fixture to attach an optical plate thereto. In some instance a phosphor is placed over at least a portion of a reflective cavity. In some instances an alignment guide to position the optical plate on a preselected orientation is added.

Disclosed herein are aspects of exemplary implementations of a molded reflector body having a common body with a shared top and a plurality of reflective cavities each having an open input end and open output end; the output end aligned with the shared top; and, a fixture to attach an optical plate thereto. In some instances a phosphor is placed over at least a portion of a reflective cavity. In some instances a mounting fixture to affix the reflector body to a surface is added. The mounting fixture can be a plurality of legs with catches that mate into surface catches.

Disclosed herein are aspects of exemplary implementations of a reflector body having a transmissive optical reflector system, the system including a molded reflector with a common, unitary or unified body; a shared top and a plurality of reflective cavities each having an open input end and open output end; the output end aligned with the shared top; a fixture to attach an optical plate thereto; a substantially planar plate with a top surface, a bottom surface, a periphery and an attachment which mates with the fixture on the top of the reflector body; a plurality of separate transmissive regions or zones on the top surface of the plate; and, a phosphor mix in each region. In some instances a plurality of legs each attached to the reflector body; and a catch on each leg. A mounting surface, board or work piece may be included with latches that correspond to each leg catch; and, light emitting diodes (LEDs) capable of producing an illumination positioned on the surface and oriented whereby at least one LED is at the open input end of each reflective cavity. In some instances vents are formed at the input ends.

Disclosed herein are aspects of exemplary implementations of a reflector body having a transmissive optical reflector system, the system including a molded reflector with a common, unitary or unified body; a shared top and a plurality of reflective cavities each having an open input end and open output end; the output end aligned with the shared top; a fixture to attach an optical plate thereto; a substantially planar plate with a top surface, a bottom surface, a periphery and an attachment which mates with the fixture on the top of the reflector body; a plurality of separate transmissive regions or zones on the top surface of the plate; and, a phosphor mix in each region. In some instances a plurality of legs each attached to the periphery of the planar plate; and a catch on each leg. A surface, workpiece or board, may be added. The surface having latches that correspond to each leg catch; and, light emitting diodes (LEDs) capable of producing an illumination positioned on the surface and oriented whereby at least one LED is at the open input end of each reflective cavity.

### DRAWINGS

The disclosure, as well as the following further disclosure, is best understood when read in conjunction with the appended drawings. For the purpose of illustrating the disclosure, there are shown in the drawings exemplary implementations of the disclosure; however, the disclosure is not limited to the specific methods, compositions, and devices disclosed. In addition, the drawings are not necessarily drawn to scale. In the drawings:

FIGS. 1A-1C illustrate a common body reflective unit with a shared top and a plurality of reflective cavities.

FIG. 2 illustrates different LCA mounting implementations on a reflective unit

FIG. 3 illustrates mixed light output from a reflective unit with LCAs.

FIGS. 4A-4C illustrate aspects of mating LCAs with a reflective unit forming a zoned optical cup (ZOC).

FIGS. 5-7 illustrate aspects of exemplary implementations of reflective units.

FIG. 8 illustrates mixed light output from an angled reflective unit with separate LCAs.

FIGS. 9 and 10 illustrate aspects of workpiece mounting for ZOCs.

FIGS. 11-13 illustrate additional reflective units with shared tops and a plurality of reflective cavities.

FIG. 14 is a cut away of a ZOC showing aspects of a ZOC with an angled LCA and common mixing unit.

The general disclosure and the following further disclosure are exemplary and explanatory only and are not restrictive of the disclosure, as defined in the appended claims. Other aspects of the present disclosure will be apparent to those skilled in the art in view of the details as provided herein. In the figures, like reference numerals designate corresponding parts throughout the different views. All callouts and annotations are hereby incorporated by this reference as if fully set forth herein.

### FURTHER DISCLOSURE

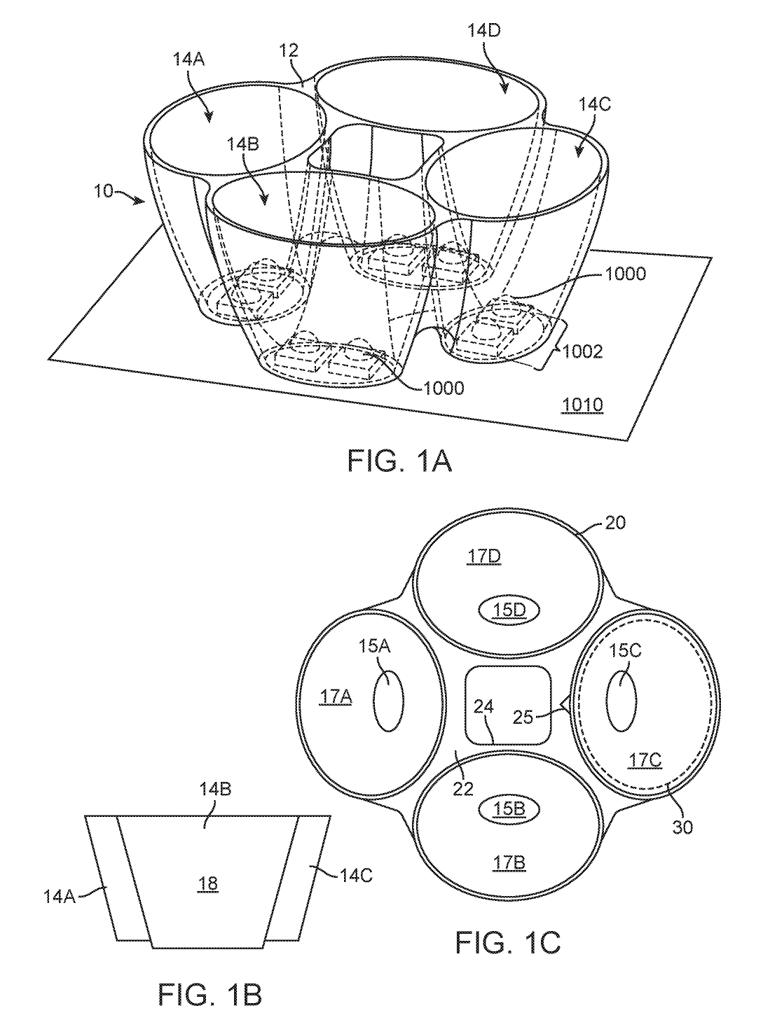

Light emitting diode (LED) illumination has a plethora of advantages over incandescent to fluorescent illumination. Advantages include longevity, low energy consumption and small size. White light is produced from a combination of LEDs utilizing phosphors to convert the wavelengths of light produced by the LED into a preselected wavelength or range of wavelengths. FIGS. 1A-1C illustrate a reflective unit 10 with a shared top 12 and a plurality of reflective cavities 14A-D. Multiple cavities forming a unifying body provide for close packing of the cavities to provide a small reflective unit. That unit accepts a plethora of lumo converting appliances (LCAs). The reflector body is a modular component which can be utilized with a wide variety of LCAs. In some instances LCAs can be replaced or changed without disturbing the reflector body or associated LEDs.

Each cavity is generally conical and in some instances frustoconical, ellipsoidal or paraboloidal and has an open bottom 15A-D, an open top 16A-D, a separate annular interior wall 17A-D, and a common annular exterior wall 18. The interior wall may be constructed of a highly reflective material such as plastic and metals which may include coatings of highly reflective materials, PTFE (polytetrafluoethylene), Spectralan™, Teflon™ or any metal or plastic coated with TiO2 (Titanium dioxide), Al2O3 (Aluminum oxide), BaSo4 (Barium Sulfide) or other suitable material. In operation the reflective unit is fixed on a predetermined arrangement over LEDs 1000 in clusters 1002 of two or more LEDs. The LEDs are mounted on a work surface 1010 such as a PCB or mounted as chip on board, chip on ceramic or other suitable work surface to manage heat and electrical requirements and hold the LEDs. The open top of each cavity terminates in peripheral ring 20. The peripheral rings are formed as part of the common joist 22 between the cavities. A vent (which also may act as an alignment guide) 24 is formed between the tops of the cavities. In other instance an alignment key 25 may be formed on the joist. The alignment key cooperates with a light converting appliance (LCA) to limit mounting of an LCA to a particular LCA or in a predetermined orientation.

The illustration of four cavities is not a limitation; those of ordinary skill in the art will recognize that a two, three, four, five, or more reflective cavity device is within the scope of this disclosure. Moreover, those of ordinary skill in the art will recognize that the specific size and shape of the reflective cavities in the unitary body may be predetermined to be different volumes and shapes; uniformity of reflective cavities for a unitary unit is not a limitation of this disclosure.

In some instances a wall coating phosphor (WCP) 30 may be added to at least a portion of one or more cavities. The WCP is used to convert the wavelength of light from LEDs 1000 into a different wavelength.

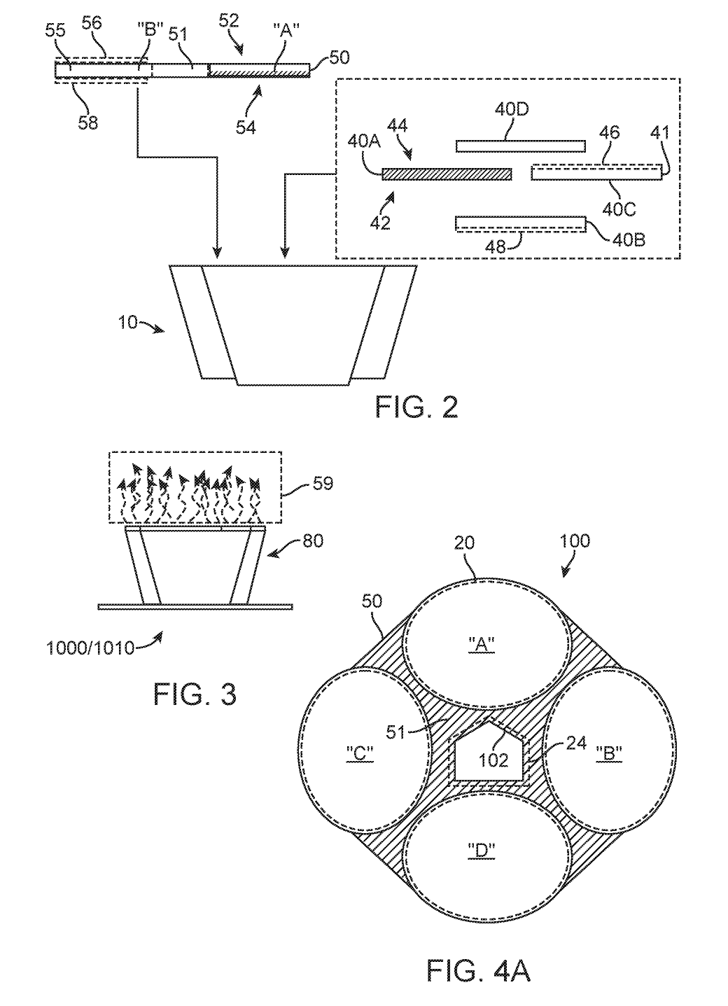

FIG. 2 illustrates the ubiquitous reflective unit 10 and different LCA mounting variations and FIG. 3 is a diagram of mixing and blending beyond the cluster of LCAs. The LCAs may be individual transmissive elements 40A-D, each being tuned for a predetermined LED source and predetermined reflective cavity, or they may be a unitary transmissive element 50 having a plurality of sub elements and sharing a common support 52.

Separate LCAs 40A-40D each have a bottom side 42 and a top side 44. A transmissive material such as glass, sapphire, polymer, hardened silicone, and plastic may be used to form an LCA base 41 to be coated with a binder photoluminescence coating. The LCA may also be formed of phosphor doped epoxy, phosphor doped silicone rubber, phosphor doped PET, and phosphor doped polymer and transmissive materials doped with quantum dots.

Photoluminescence materials may include an inorganic or organic phosphor, silicate-based phosphors, aluminate-based phosphors, aluminate-silicate phosphors, nitride phosphors, sulfate phosphor, oxy-nitrides and oxy-sulfate phosphors, or garnet materials including luminescent materials such as those disclosed in co-pending application PCT/US2016/015318 filed Jan. 28, 2016, entitled “Compositions for LED Light Conversions,” the entirety of which is hereby incorporated by this reference as if fully set forth herein. The phosphor materials are not limited to any specific examples and can include any phosphor material known in the art.

Quantum dots are known in the art. The color of light produced is from the quantum confinement effect associated with the nano-crystal structure of the quantum dots. The energy level of each quantum dot relates directly to the size of the quantum dot.

The photoluminescence material(s) may be coated as a top side coating 46 and/or coated as a bottom side coating 48. It is also possible to have a photoluminescence doped separate LCA and add a top or bottom side coating.

A unitary transmissive element 50 supporting specific LCAs “A” and “B” is shown. Each LCA has a support structure 51, bottom side 52, and a top side 54. A transmissive material is used to form the LCA and it can be doped with photoluminescence materials such as phosphors and quantum dots forming LCA “A”. LCA “B” is an LCA base 55 coated with photoluminescence materials with a top side coating 56 and a bottom side coating 58. In some instances a doped LCA may also be coated with additional photoluminescence material. The unitary transmissive element has a circumferential outer edge 57.

It is preferable that a minimum distance from the LEDs to the open top is maintained whereby hot spots on the LCA are minimized and temperature at the LCA is kept at a nominal level. However, due to the novel combination of separate LCA juxtaposed in close proximity on the common unit 10 additional light mixing occurs on the exterior of the LCAs wherein the multiple separate LCA light outputs blend. A multi cavity multi LCA illumination device 80 is shown in FIG. 3. Such an arrangement can reduce non-uniformity final light output 59. Unlike traditional LED reflector combinations which suffer from hot spots and critical distance tolerances, the post LCA mixing of light from the multiple chambers within the common unit 10 blends and forms a substantially uniform output with less critical tolerances. Specifically the same reflective cavities may be used with a variety of LED sources and a variety of LCAs without having to change the reflective unit 10 and/or the LCAs.

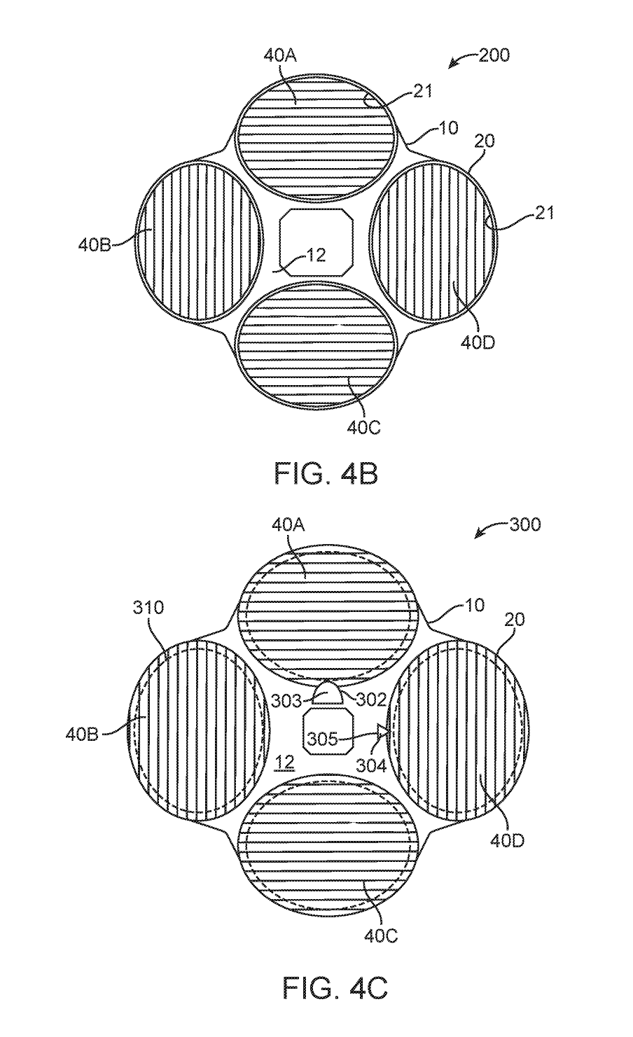

FIG. 4A illustrates a top view of aspects of a multi cavity multi LCA illumination device 100 having a unitary transmissive element 50 attached thereto. The support structure is formed of a plastic, metal, epoxy, glass, sapphire, polymer, or other material which is not effected by the temperatures in the range of about −40 C to about 100 C produced by LEDs operating within the reflective cavities 14A-D. LCAs “A”-“D” are shown. In some exemplary alignments of the LCAs of the unitary transmissive element 50 via cooperation of an alignment latch 102 mating to a vent 24 is shown. In this fashion during assembly LCAs “A” . . . “n” (in this case “A”-“D”) are aligned with specific reflective cavities and specific LEDs associated with each reflective cavity. The LCAs are shown extending beyond the peripheral ring 20; in this fashion an LCA which may be less uniform in the disbursement of the photoluminescence material at its edges positions the more uniform area in the path of the open tops 16.

FIG. 4B illustrates a top view of aspects of a multi cavity multi LCA illumination device 200 having separate transmissive elements 40A-40D attached thereto. In this exemplary implementation aspects of mounting LCAs into a reflective cavity are shown. The LCAs are shown fit inside the peripheral ring 20 of each reflective cavity at the top portion of the 21 of the annular interior wall 17.

Those of ordinary skill in the art will recognize that a single LCA could be mounted in the below fashion while a plurality of other LCAs may be part of a unitary structure 50 and mounted over a portion of the reflective cavities in a unit and this is within the scope of this disclosure.

FIG. 4C illustrates a top view of aspects of a multi cavity multi LCA illumination device 300 having separate transmissive elements 40A-40D attached thereto. In this exemplary implementation aspects of mounting LCAs over the peripheral ring 20 are shown.

The edges 310 of LCAs 40A-40D are shown extending beyond the peripheral ring 20 which provides room for some non-uniformity in the LCA of disbursement of the photoluminescence material at the LCA's edges thereby positioning the more uniform area in the path of the open tops 16.

Additional aspects of alignment disclosed include LCA 40A providing an arc shaped catch 302 which mates with a shaped latch 303 on the shared top 12. In another instance a shaped latch 304 extending off the edge 310 of the LCA 40D fits into a matching shaped catch 305 in the shared top 12. Via alignment features a standardized unit 10 can be the base for a variety of LCAs and the LCAs can be identified, correlated to a unit and/or positioned via the alignment features discussed above.

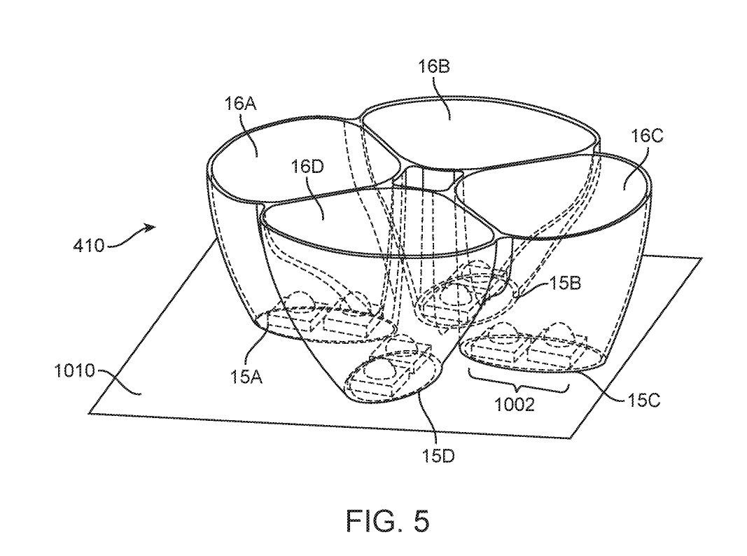

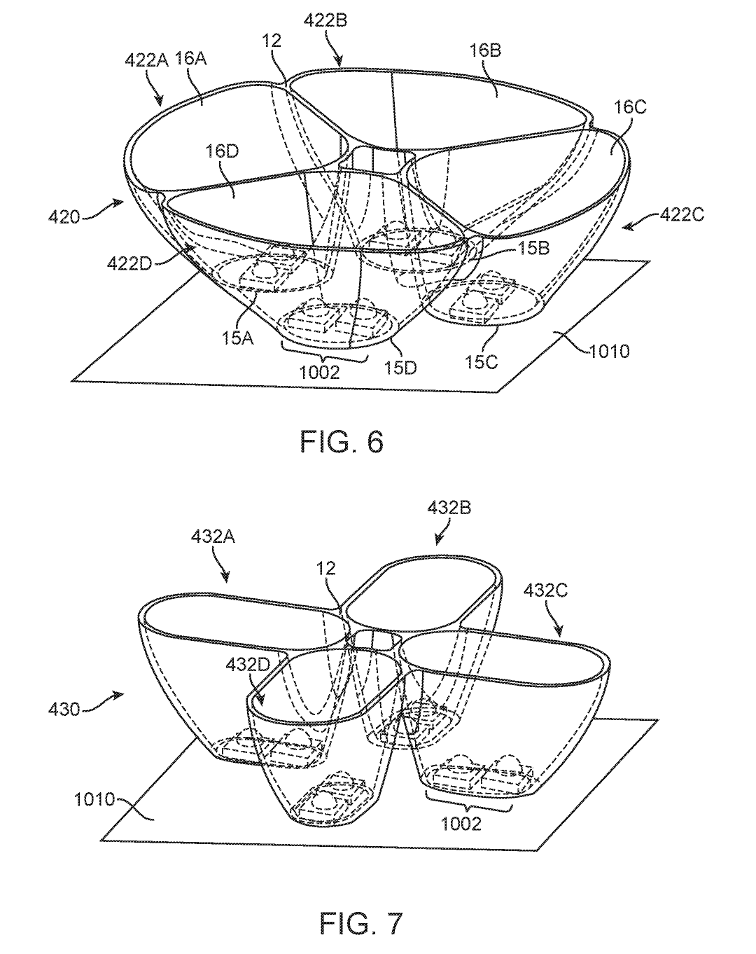

FIGS. 5-7 show aspects of units 410, 420, 430, each of which illustrates a different form of reflective cavities each of which is formed with a shared top 12. Reflective cavities 402A-402D have a more triangular open top 16A-16D then the oval open tops 16A-16D of unit 10.

The ratio of the open tops 16A-16D of reflective cavities 422A-422D of reflective unit 420 is far greater than the ratio of open tops to open bottoms of reflective unit 10 or reflective unit 410. If the height of the reflective cavities is maintained substantially the same the larger ratio indicates a more obtuse angle of the interior annular wall to the work surface 1010. The adjustment of the angle will alter the dispersion of the light from the LED cluster 1002. The larger angle also provides a large area of reflective surface to interact with that portion of photons reflected back into the reflective cavity from the LCA during operation. Reflective cavities 432A-432D have a more elongated open top 16A-16D then the oval open tops 16A-16D of unit 10.

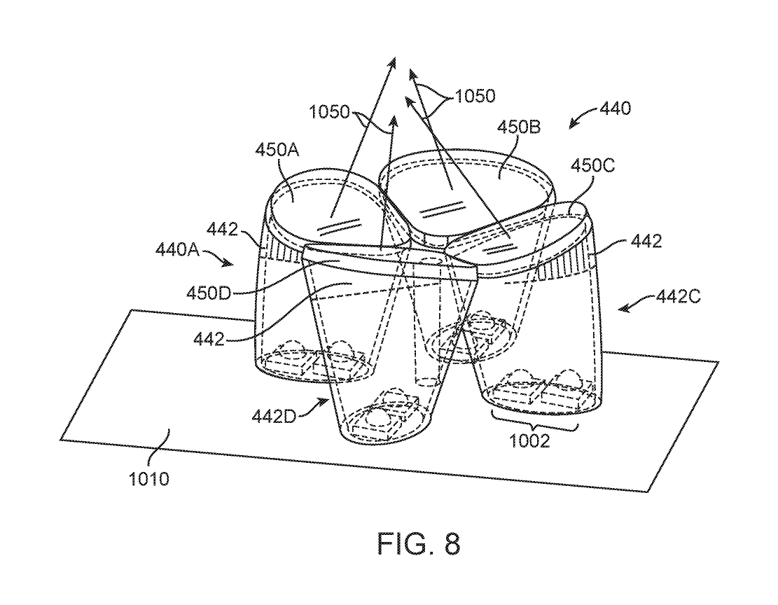

FIG. 8 shows aspects of an angled illumination and mixing device 440. A group of reflective cavities 440A-440D are connected at a shared top (not shown). The reflective cavities at the open top have an extended back side 442 thereby directing, steering and/or angling each of the open tops in a predetermined direction. The LCAs 450A-450D affixed to the open tops of the reflective cavities are thereby non parallel to the work piece 1010 and are shown directing light output 1050 toward a center focal point thereby further blending the mixing the light output from the different LED clusters 1002 which have passed through the LCAs.

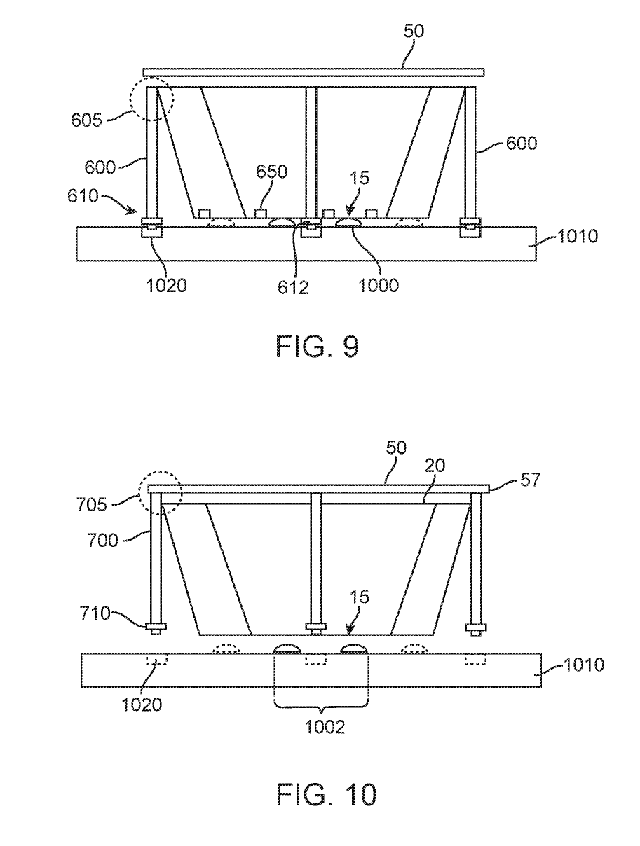

FIGS. 9 and 10 show aspects of board or workpiece mounting of a ZOC. Mounting variations shown include reflective body 10 to work piece mounting and transmissive element 50 to board/workpiece mounting.

Legs 600 are formed or attached to reflective body 10 along the exterior annular wall at an interface 605. The legs have a free end 610 which provides a catch 612 that fits into a latch 1020 formed in the work piece 1010. Those of ordinary skill in the art will recognize that a plethora of latches and catches are within the scope of this disclosure, which may include press fit, barbed ends, friction fit, and the like. The latch is positioned to orient the ZOC and in particular the open bottoms 15A-D (15) over LEDs 1000 or clusters 1002 such that the LEDs are properly positioned in the open bottom for use with the ZOC. Vents 650 may be provided around the open bottom 15A-D to allow airflow in and out of the ZOC to help manage temperature inside the ZOC.

Legs 700 are formed or attached to a unitary transmissive element 50 along the along the circumferential outer edge 57 at an interface 705. The transmissive element 50 presses down against the peripheral ring 20 pressing the open bottom 15 against the work piece 1010 when mounted.

Each leg has a free end 710 which provides a catch that fits into a latch 1020 formed in the work piece 1010. Those of ordinary skill in the art will recognize that a plethora of latches and catches are within the scope of this disclosure, which may include press fit, barbed ends, friction fit, and the like. The latch is positioned to orient the ZOC and in particular the open bottoms 15A-D over LEDs 1000 or clusters 1002 such that the LEDs are properly positioned in the open bottom for use with the ZOC. Vents may be provided around the open bottom 15A-D to allow airflow in and out of the ZOC to help manage temperature inside the ZOC.

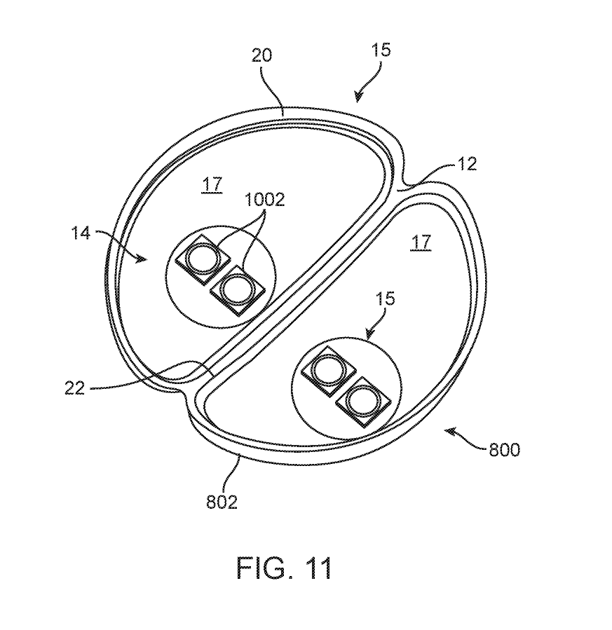

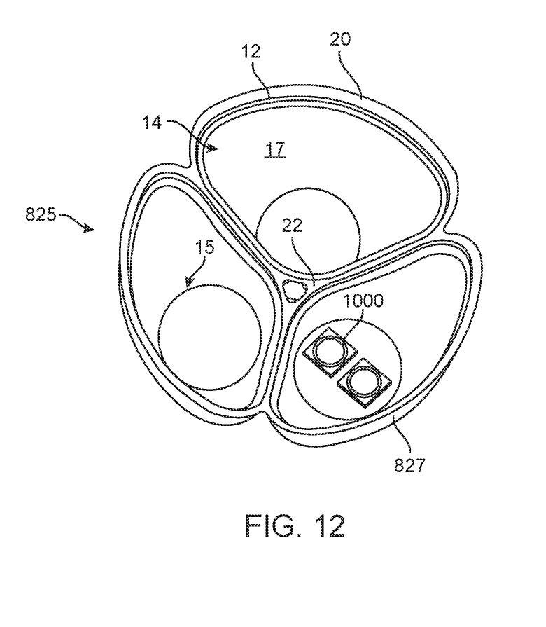

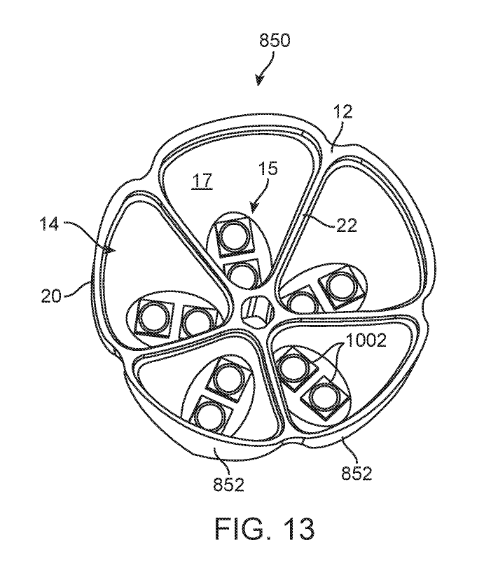

FIGS. 11-13 illustrate common body reflective units with two, three and five cavities respectively. In each instance the cavities may be homogeneous in shape or maybe non homogeneous. In each of these units the LCA (not shown) may be used with either a unitary transmissive element or with separate transmissive elements.

The common reflector bodies 800, 825 and 850 each have reflective cavities (802, 827 and 852 respectively) which are generally conical and in some instances frustoconical, ellipsoidal or paraboloidal and each has an open bottom 15 an open top 16, a separate annular interior wall 17. The open top of each cavity terminates in peripheral ring 20. The peripheral rings are formed as part of the common joist 22 between the cavities.

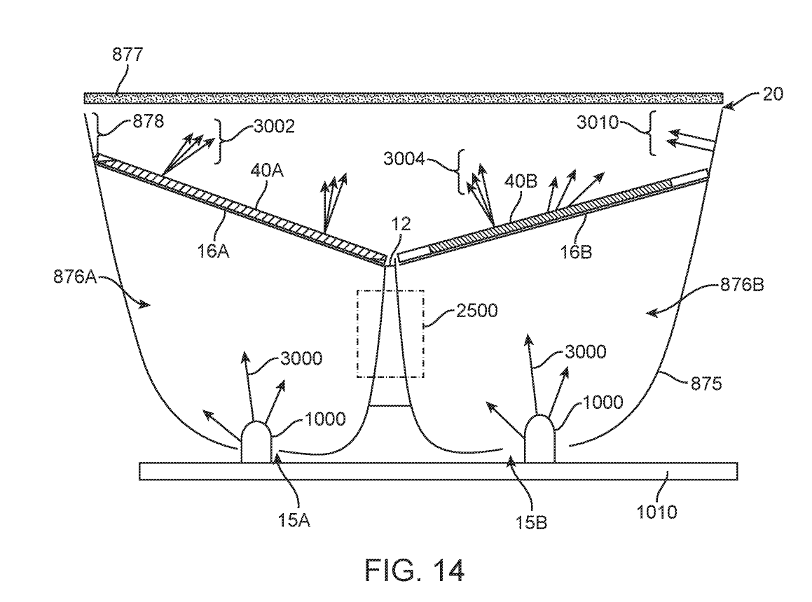

Shown in FIG. 14 are aspects of an angled ZOC 870. The common reflective body 875 has reflective cavities 876A and 876B. The open tops 16A and 16B of the cavities are angled towards a center region 2500 of the angled ZOC. The LCAs 40A and 40B are affixed over the angled open tops. Wavelengths of light 3000 are produced by each LED 1000 or LED cluster 1002. That light 3000 is reflected within the cavity and the portion of it that passes through each LCA is tuned or otherwise adjusted via the photoluminescence materials to produce selected wavelengths of output. Through LCA 40A wavelength 3002 are provided; through LCA 40B wavelengths 3004 are provided. Above the open tops 55 and the LCAs is a mixing portion 878 of the common annular interior wall of the reflective body 370 the light passing through the LCAs is reflected within the common reflective body 370 and a portion of it off the mixing portion 878 providing a blended or mixed output 3010.

It will be understood that various aspects or details of the invention(s) may be changed without departing from the scope of the disclosure and invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention(s).

1. A transmissive optical plate having discreet zones comprising:
a molded substantially planar plate with an annular edge, a top surface and a bottom surface;
a plurality of separate transmissive regions or zones on the top surface of the plate;
an attachment located on along the circumference of the plate; and,
a phosphor mix in each region.

2. The optical plate of claim 1 wherein the plate is a generally circular disk.

3. The optical plate of claim 1 wherein the attachment is along the periphery of the plate.

4. The optical plate of claim 1 wherein the attachment is on one of the bottom surfaces of the plate and the bottom surface of the plate near the periphery.

5. The optical plate of claim 1 wherein: the top is formed of one or more of polymers, plastics, glass, sapphire; and,
wherein each transmissive region is formed of at least one of phosphor doped epoxy, phosphor doped silicone rubber, phosphor doped PET, and phosphor doped polymer.

6. (canceled)

7. The optical plate of claim 5 wherein the phosphor doping is one of substantially uniform on the region and non-uniform on the region.

8. (canceled)

9. The optical plate of claim 1 further comprising a positioning cue to align the transmissive regions of the plate in a predetermined orientation over a plurality of illumination sources.

10. A transmissive optical plate having discreet zones comprising:
a molded substantially planar plate with an annular edge, top and bottom surfaces, and having a plurality of open lumo guides forming zones there through;
an attachment located on along the circumference of the plate; and,
a lumo converting appliance containing at least a phosphor doped substrate affixed in each guide.

11. The optical plate of claim 10 wherein the plate is a generally circular disk.

12. The optical plate of claim 11 wherein the attachment is along the periphery of the plate.

13. The optical plate of claim 10 wherein each LCA is at least one of phosphor doped epoxy, phosphor doped silicone rubber, phosphor doped PET, and phosphor doped polymer.

14. The optical plate of claim 10 wherein each LCA is a transmissive base formed of at least one of glass, sapphire, and polymer coated with a binder containing one or more phosphors or quantum dots.

15. The optical plate of claim 10 wherein the phosphor doping of each LCA is one of substantially uniform and non-uniform.

16. (canceled)

17. A molded reflector body comprising:
a common body with a shared top and a plurality of frustoconical or ellipsoidal sections forming reflective cavities each having an open input end and open output end;
each open output end has a non-homogeneous outline wherein a series of curved regions having curves with different arcs form the outline;
the output end aligned with the shared top; and,
a fixture to attach an optical plate thereto.

18. The molded reflector of claim 17 further comprising phosphor added to at least a portion of the reflective cavities.

19. The molded reflector of claim 17 further comprising vents formed at the input ends.

20. The molded reflector of claim 17 further comprising an alignment guide to position the optical plate on a preselected orientation.

21. The molded reflector of claim 17 further comprising a mounting fixture to affix the reflector body to a surface via a plurality of legs with catches that mate into surface catches.

22. (canceled)

23. A transmissive optical reflector system, the system comprising:
a molded reflector body with a common body, a shared top and a plurality of frustoconical or ellipsoidal sections forming reflective cavities each having an open input end and open output end;
each open output end has a non-homogeneous outline wherein a series of curved regions having curves with different arcs form the outline;
the output end aligned with the shared top;
a fixture to attach an optical plate thereto;
a substantially planar plate with a top surface, a bottom surface, a periphery and an attachment which mates with the fixture on the top of the reflector body;
a plurality of separate transmissive regions or zones on the top surface of the plate; and,
a phosphor mix in each region.

24. The optical reflector system of claim 23 further comprising:
a plurality of legs each attached to the reflector body; and
a catch on each leg.

25. The optical reflector system of claim 24 further comprising a surface with latches that correspond to each leg catch; and,
light emitting diodes (LED) capable of producing an illumination positioned on the surface and oriented whereby at least one LED is at the open input end of each reflective cavity.

26-27. (canceled)

28. The optical reflector system of claim 24 further comprising a surface with latches that correspond to each leg catch; and, light emitting diodes (LED) capable of producing an illumination positioned on the surface and oriented whereby at least one LED is at the open input end of each reflective cavity.

29. The molded reflector body of claim 17, wherein output end is generally triangular.

30. The molded reflector body of claim 23, wherein output end is generally triangular.
